(19) United States
(12) Patent Application Publication
(10) Pub. No.: US 2022/0372193 A1
(43) Pub. Date: Nov. 24, 2022

(54) A Method of Functionalizing Fluorinated Polymers, a Functionalized Fluorinated Polymer and Coating Compositions Thereof

(71) Applicant: 3M INNOVATIVE PROPERTIES COMPANY, St. Paul, MN (US)

(72) Inventors: Frans A. Audenaert, Kaprijke (BE); Klaus Hintzer, Kastl (DE); Alain G. Verschuere, Melsele (BE)

(21) Appl. No.: 17/767,066

(22) PCT Filed: Nov. 6, 2020
(86) PCT No.: PCT/IB2020/060462

§ 371 Date: Apr. 7, 2022

Related U.S. Application Data
(60) Provisional application No. 62/934,598, filed on Nov. 13, 2019.

(51) Int. Cl. C08F 259/08; C09D 151/00; C09D 7/20; C09D 7/40

(52) U.S. Cl. CPC C08F 259/08; C09D 151/003; C09D 7/20; C09D 7/40

(57) ABSTRACT

Described herein is method of functionalizing fluorinated polymers, wherein a reaction compound is grafted onto a fluorinated polymer, wherein the fluorinated polymer comprises at least one Br, I, and Cl group and is free of —CH₂CH₂— linkages. In one embodiment, the functionalized fluorinated polymer comprises a perfluorinated polymer backbone with pendent groups therefrom is disclosed, wherein at least one pendent group is according to formula I: where Rf is a bond, or a divalent perfluorinated group, optionally comprising at least one in-chain ether linkage; Z is I, Br, or Cl; and X comprises a functional group selected from the group consisting of an alcohol; phosphorous acid and salts thereof; phosphoric acid and salts thereof; a silane; an amine; an amide; a hydrocarbon, optionally comprising an in-chain oxygen, nitrogen, or sulfur linkage; a carboxylic acid and salts thereof; an ester; a sulfonyl fluoride, a sulfonic acid and salts thereof; and combinations thereof. Such functionalized fluorinated polymers may be used in coating compositions.

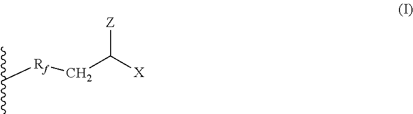

### TECHNICAL FIELD

A method of functionalizing fluorinated polymers is disclosed, along with the resulting functionalized fluorinated polymers. In one embodiment, the resulting functionalized fluorinated polymers are used in coating compositions on substrates.

### SUMMARY

There is a desire to identify a novel way to introduce functionality into a fluorinated polymer. Such functionality can be useful, for example, to improve adhesion of the fluorinated polymer onto substrates.

In one aspect, a method of grafting a functional group onto a fluorinated polymer to form a functionalized fluorinated polymer is disclosed. The method comprising:

dissolving the fluorinated polymer in a non-aqueous vehicle, wherein the fluorinated polymer (i) comprises at least one Br, I, and Cl group and (ii) is substantially free of —CH₂CH₂— linkages; and reacting the fluorinated polymer with a reaction compound in the presence of a free radical initiator, wherein the reaction compound has (a) a non-fluorinated terminal olefin group and (b) comprises a functional group.

In one embodiment, a functionalized fluorinated polymer is disclosed comprising a fluorinated polymer backbone substantially free of —CH₂CH₂— linkages with pendent groups therefrom, wherein at least one pendent group is according to formula I:

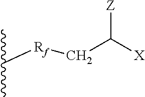

where Rf is a bond or a divalent perfluorinated group, optionally comprising at least one in-chain ether linkage, Z is I, Br, or Cl; and X comprises a functional group selected from the group consisting of an alcohol; a phosphorous acid and salts thereof; a phosphoric acid and salts thereof; a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof; and combinations thereof.

In yet another embodiment, a coating composition is disclosed. The coating composition comprising (i) a functionalized fluorinated polymer comprising a fluorinated polymer backbone substantially free of —CH₂CH₂— linkages with pendent groups therefrom is disclosed, wherein at least one pendent group is according to formula I:

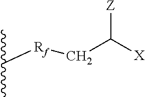

where Rf is a bond or a divalent perfluorinated group, optionally comprising at least one in-chain ether linkage; Z is I, Br, or Cl; and X comprises a functional group selected from the group consisting of an alcohol; phosphorous acid and salts thereof; phosphoric acid and salts thereof, a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof; and combinations thereof; and (ii) a fluorinated solvent.

In still another embodiment, an article comprising a substrate and a fluoropolymer composition bonded thereto is disclosed, the fluoropolymer composition comprising a functionalized fluorinated polymer comprising a fluorinated polymer backbone substantially free of —CH₂CH₂— linkages with pendent groups therefrom, wherein at least one pendent group is according to formula I:

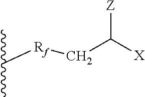

where Rf is a bond or a divalent perfluorinated group, optionally comprising at least one in-chain ether linkage; Z is I, Br, or Cl; and X comprises a functional group selected from the group consisting of an alcohol; phosphorous acid and salts thereof; phosphoric acid and salts thereof, a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof; and combinations thereof.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term “a”, “an”, and “the” are used interchangeably and mean one or more; and “and/or” is used to indicate one or both stated cases may occur, for example A and/or B includes, (A and B) and (A or B);

“backbone” refers to the main continuous chain of the polymer; “crosslinking” refers to connecting two pre-formed polymer chains using chemical bonds or chemical groups;

“cure site” refers to functional groups, which may participate in crosslinking; “interpolymerized” refers to monomers that are polymerized together to form a polymer backbone;

“monomer” is a molecule which can undergo polymerization which then form part of the essential structure of a polymer; and “perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

In the present disclosure, a method for adding functionalization onto a fluoropolymer is disclosed. Such functionalized fluorinated polymers may be used, for example, in coating compositions.

Functionalized fluorinated polymer

Adding functionalized moieties onto fluoropolymers, especially perfluorinated polymers can be especially challenging due to the inherent lack of reactivity of perfluorinated groups.

Disclosed herein is a functionalized fluorinated polymer, wherein the polymer backbone is substantially free of —CH₂CH₂— linkages and comprises pendent groups off the polymer backbone, wherein at least one pendent group is according to formula I:

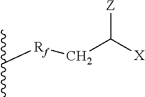

Where the wavy line represents the polymer backbone, Rf is a bond or a divalent perfluorinated radical; Z is I, Br, or Cl; and X comprises a functional group selected from the group consisting of an alcohol; phosphorous acid and salts thereof; phosphoric acid and salts thereof; a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof; and combinations thereof. As will be discussed below, the fluorinated polymer is functionalized via a free radical reaction between the Z moiety and an ethylenically unsaturated group. The Z moiety may be present as an endgroup, where polymerization initiates or terminates, or as a side-chain, depending on how the Z moiety was incorporated into the polymer. Thus, as used herein, a pendent group refers to both side chains along the polymer backbone as well as endgroups located at the terminal ends of the polymer backbone.

When Rf is a divalent perfluorinated radical, Rf may be linear, branched, and/or cyclic in nature. In one embodiment, Rf comprises at least 1, 2, 3, or even 4 carbon atoms. In one embodiment, Rf comprises no more than 6, 8, 10, 12, 14, 16, or even 18 carbon atoms.

In one embodiment, Rf is a linear perfluorinated alkylene, such as —(CF₂)ₙ—, where n is an integer of at least 1, 2, 3, or even 4; and at most 5, 6, 7, or even 8. In one embodiment, Rf is a branched perfluorinated alkylene such as —[CF₂CF(CF₃)]ₘ)— or —[(CF(CF₃)CF₂]ₘ)—, where m is an integer of at least 1, 2, 3, 4; and at most 5, 6, 7, or even 8.

In one embodiment, the divalent perfluorinated radical Rf may contain at least one in-chain oxygen atom. For example, Rf may comprise —(CF₂)ₚ—O—(CF₂)_{q}—, —(OCF₂CF₂)_{q}—, (OCF₂CF(CF₃))ₚ—, —(OCF(CF₃)CF₂)ₚ—, —(CF₂CF(CF₃))ₚ—O—(CF₂)_{q}—, and/or —(CF(CF₃)CF₂)—O—(CF₂)_{q}—, wherein p is an integer of 1, 2, 3, 4, 5, 6, 7, 8, 9, 10, or 11 and q is an integer from 1, 2, 3, 4, 5, 6, 7, 8, 9, 10, or 11, such that, if p and q are both present, the sum of p+q is from 2, 3, 4, 5, 6, 7, 8, 9, 10, 11, or 12.

The backbone of the functionalized fluorinated polymer is substantially free of —CH₂CH₂— linkages, meaning that the fluorinated polymer comprises less than 0.5, 0.1, 0.05, or even 0.01 mol % of —CH₂CH₂— linkages, or even no —CH₂CH₂— linkages along the polymer backbone versus moles of monomer used to make the fluorinated polymer.

The fluorinated polymers that can be functionalized with functional group, X, to form the functionalized fluorinated polymers, are discussed below. A functional group, as disclosed herein, is a group that alters the properties of the original fluorinated polymer. The functional group is non-reactive under free radical conditions, but comprises a group which has functionality such as a polar functionality, ionic character, etc., which can be subsequently utilized to improve adhesion to substrates (including inorganic and organic). Exemplary functional groups include: an alcohol; a phosphorous acid and salts thereof; a phosphoric acid and salts thereof, a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof; and combinations thereof.

Method of Making

Disclosed herein is a process for making the functionalized fluorinated polymer disclosed above, wherein a reaction compound having a hydrocarbon terminal olefin group and a functional group is grafted onto a fluorinated polymer in solution, resulting in the incorporation of the functional group into the fluorinated polymer.

The grafting method disclosed herein may be used for functionalizing partially fluorinated polymers, as well as perfluorinated polymers. However, this process is especially advantageous for perfluorinated polymers, which are difficult to react. A perfluorinated polymer, means that, excluding the sites where the polymerization initiates and terminates, the fluorinated polymer comprises no C—H bonds and the C-H bonds are primarily replaced with C—F bonds, and optionally C—Br, C—I, or C—Cl bonds. Preferably, the polymer comprises at least 70%, preferably at least 71% fluorine by weight. A partially fluorinated polymer means that, excluding the sites where the polymerization initiates and terminates, the fluorinated polymer comprises both C—F bonds and C—H bonds and optionally, carbon-bromine, carbon-chlorine, and carbon-iodine bonds. Preferably, the partially fluorinated polymer is highly fluorinated wherein at least 65, 70, 75, 80, or even 85% of the C—H bonds in the polymer are replaced by C—F bonds; and at most 90, 95, or even 99% of the C—H bonds in the polymer are replaced by C—F bonds.

Typically, the fluorinated polymer is derived from one or more fluorinated monomer(s) such as TFE (tetrafluoroethylene), VF (vinyl fluoride), VDF (vinylidene fluoride), HFP (hexafluoropropylene), pentafluoropropylene, trifluoroethylene, CTFE (chlorotrifluoroethylene), perfluoro ethers, and combinations thereof.

Exemplary perfluoro ether monomers are of the Formula (II)

CF₂=CF(CF₂)ₕO(R_{f}^{c}O)ᵢ(R_{f}^{b}O)ₖR_{f}^{a} (II)

where R_{f}^{b} and R_{f}^{c} are independently linear or branched perfluoroalkylene radical groups comprising 2, 3, 4, 5, or 6 carbon atoms, h is 0 or 1, i and j are independently an integer selected from 0, 1, 2, 3, 4, 5, 6, 7, 8, 9, and 10, and R_{f}^{a} is a perfluoroalkyl group comprising 1, 2, 3, 4, 5, or 6 carbon atoms. Exemplary perfluoroalkyl vinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂. Exemplary perfluoroalkyl allyl ether monomers include: perfluoro (methyl allyl) ether (CF_{2═}CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂.

The fluorinated polymers are substantially free of —CH₂CH₂— linkages (as defined above) and comprise at least one pendent I, Br and/or Cl group. In one embodiment, the fluorinated polymer comprises at least 0.4, 0.6, 0.8, 1, or even 1.5% by weight and at most 2, 3, 4, or even 5% by weight of I, Br, and Cl atoms versus the total weight of the fluorinated polymer. Due to reactivity, iodine atoms are preferred.

The Br, I, and Cl groups in the fluorinated polymer may be a result of polymerizing the fluorinated monomers in the presence of a chain transfer agent and/or cure site monomer.

Exemplary chain transfer agents include: an iodo-chain transfer agent, or a bromo-chain transfer agent. For example, suitable chain transfer agent include the formula of R_{f}^{d}Z_{y}, where R_{f}^{d} is a perfluoroalkyl or chloroperfluoroalkyl group having 3 to 12 carbon atoms; Z is I or Br, and y=1 or 2. Exemplary chain transfer agents include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof.

In one embodiment, the fluorinated polymers may be derived from one or more compounds of the formula: (a) CF₂═CF(U), wherein: U is (i) I, Br or Cl; or (ii) R_{f}^{e}—Z wherein Z=I or Br and R_{f}^{e}=a perfluorinated or partially fluorinated alkylene group optionally containing at least one ether linkage. Exemplary compounds include: CF_{2═}CHI, CF_{2═}CFI, CF₂═CFCF₂I, CF_{2═}CFCH₂CH₂I, CF₂═CFCF₂CF₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CF₂═CHBr, CF₂═CFBr, CF₂═CFCF₂Br, CF₂═CFOCF₂CF₂Br, CF₂═CFCl, CF₂═CFCF₂Cl, and combinations thereof.

In one embodiment, the fluorinated polymer is amorphous, meaning that there is an absence of long-range order (i.e., in long-range order the arrangement and orientation of the macromolecules beyond their nearest neighbors is understood). An amorphous fluoropolymer has no detectable crystalline character by DSC (differential scanning calorimetry), meaning that if studied under DSC, the fluoropolymer would have no melting point or melt transitions with an enthalpy more than 0.002, 0.01, 0.1, or even 1 Joule/g from the second heat of a heat/cool/heat cycle, when tested using a DSC thermogram with a first heat cycle starting at −85° C. and ramped at 10° C./min to 350° C., cooling to −85° C. at a rate of 10° C./min and a second heat cycle starting from −85° C. and ramped at 10° C./min to 350° C. Exemplary amorphous random copolymers may include: copolymers comprising TFE and perfluorinated vinyl ethers monomeric units (such as copolymers comprising TFE and PMVE, and copolymers comprising TFE and PEVE); copolymers comprising TFE and perfluorinated allyl ethers monomeric units; copolymers comprising VDF monomeric units as long as the copolymer is substantially free of —CH₂—CH₂— linkages; and combinations thereof. Exemplary copolymers comprising VDF monomeric units include copolymers comprising VDF and HFP monomeric units; copolymers comprising TFE, VDF, and HFP monomeric units; copolymers comprising VDF and perfluorinated vinyl ethers monomeric units (such as copolymers comprising VDF and CF₂═CFOC₃F₇) monomeric units; copolymers comprising CTFE and VDF monomeric units; copolymers comprising TFE and VDF monomeric units; copolymers comprising TFE, VDF and perfluorinated vinyl ethers monomeric units (such as copolymers comprising TFE, VDF, and PMVE) monomeric units; and copolymers comprising TFE, VDF, and perfluorinated vinyl ethers monomeric units (such as copolymers comprising TFE, VDF, and CF₂═CFO(CF₂)₃OCF₃) monomeric units.

In one embodiment, the fluorinated polymer is an amorphous fluorinated polymer derived from
(a) a fluorinated di-iodo ether compound of the following formula III:

R_{f}′—CF(I)—(CX′X′)ₐ—(Y¹)_{b}—O—R_{f}¹—Oᵥ—(Y¹)_{c}—(CX′X′)_{d}—CF(I)—R_{f}′

wherein
each R_{f}′ is independently selected from F and a monovalent perfluoroalkane having 1-3 carbons;
each Y¹ is independently selected from —CX′X′CX′R_{f}″— and —CX′R_{f}″CX′X′—;
each X′ is independently selected from F, H, and Cl;
R_{f}″ is F, or a partially fluorinated or perfluorinated alkane comprising 1-3 carbons;
R_{f}¹ is a divalent fluorinated alkylene having 1-5 carbons or a divalent fluorinated alkylene ether having 1-8 carbons and at least one ether linkage;
v is 0 or 1; and
a, b, c, and d are independently selected from an integer from 0-5, with the proviso that when v is 0, a+b is at least 1 and c+d is at least 1, with the proviso that Formula III does not contain a —CH₂CH₂— linkage; and
(b) a fluorinated monomer comprising at least one of vinylidene fluoride, tetrafluoroethylene, hexafluoropropylene, fluorinated allyl ethers, fluorinated vinyl ethers, and combinations thereof. Such fluorinated elastomers are disclosed in U.S. Pat. No. 9,982,091, herein incorporated by reference. In one embodiment, the amorphous fluorinated polymer is derived from at least 0.1, 0.5, 1.0, 1.5, or even 2.0 wt %; and at most 3.0, 3.5, 4.0, 4.5, 5.0, or even 5.5 wt % of the fluorinated di-iodo ether compound according to Formula III.

In one embodiment, the fluorinated polymer is an amorphous fluorinated polymer derived from (i) at least one iodo-containing compound selected from:
(a) I—(CF₂)_{w}—I, where w is 1, 2, 3, 4, 5, 6, 7, or 8
(b) I—(CF₂)ₙ—O—(CF₂)ₘ—(O)ₚ—(CF₂)ₒ—I where n is 2, 3, 4, 5, or 6; o is 2, 3, 4, 5, or 6; m is 1, 2, 3, 4, 5, or 6; and p is 0 or 1; and
(c) CF_{2═}CF—(CF₂)ₐ—O—(CF₂)_{b}—(O)_{c}—(CF₂)_{d}—I where a is 0 or 1, b is 1, 2, 3, 4, 5, or 6; c is 0 or 1; and d is 1, 2, 3, 4, 5, or 6; and
(d) CF₂═CF(CF₂)ₘI, where m is 1, 2, 3, 4, 5, or 6; and
   (ii) a fluorinated monomer comprising at least one of vinylidene fluoride, tetrafluoroethylene, hexafluoropropylene, (per)fluorinated allyl ethers, (per)fluorinated vinyl ethers, iodo-containing perfluoro vinyl ethers, iodo-containing perfluoro allyl ethers, and combinations thereof.

In one embodiment, the fluorinated polymer is an amorphous fluorinated polymer derived from (i) at least one bromo-containing compound selected from:
(a) Br—(CF₂)_{w}—CH₃, where w is 0, 1, 2, 3, 4, 5, 6, 7, or 8;
(b) Br—(CF₂)_{w}—Br, where w is 1, 2, 3, 4, 5, 6, 7, or 8;
(c) Br—(CF₂)ₙ—O—(CF₂)ₘ—(O)ₚ—(CF₂)ₒ—Br where n is 2, 3, 4, 5, or 6; o is 2, 3, 4, 5, or 6; m is 1, 2, 3, 4, 5, or 6; and p is 0 or 1;
(d) CF₂═CF—(CF₂)ₐ—O—(CF₂)_{b}—(O)_{c}—(CF₂)_{d}—Br where a is 0 or 1, b is 1, 2, 3, 4, 5, or 6; c is 0 or 1; and d is 1, 2, 3, 4, 5, or 6; and
(e) CF₂═CF(CF₂)ₘBr, where m is 1, 2, 3, 4, 5, or 6; and
   (ii) a fluorinated monomer comprising at least one of tetrafluoroethylene, hexafluoropropylene, vinylidene fluoride, (per)fluorinated allyl ethers, (per)fluorinated vinyl ethers, bromo- and/or iodo-containing perfluoro vinyl ethers, bromo- and/or iodo-containing perfluoro allyl ethers, and combinations thereof.

In one embodiment, the fluorinated polymer is an amorphous fluorinated polymer derived from
(a) CF₂═CF(CF₂)ₘCl, where m is 1, 2, 3, 4, 5, or 6; and
(b) a fluorinated monomer comprising at least one of tetrafluoroethylene, hexafluoropropylene, perfluorinated allyl ethers, perfluorinated vinyl ethers, and combinations thereof.

In one embodiment, the fluorinated polymer is an amorphous fluorinated polymer derived from CF_{2═}CF—Rf—Z, wherein Rf is a perfluorinated alkylene, optionally comprising at least one in-chain ether linkage and Z comprises at least one of I, Br, and Cl; and a fluorinated monomer comprising at least one of tetrafluoroethylene, hexafluoropropylene, perfluorinated allyl ethers, perfluorinated vinyl ethers, and combinations thereof.

In one embodiment, the fluorinated polymer is a fluorinated elastomer gum derived from I—(CF₂)_{w}—I wherein w is an integer from 1-8; and a fluorinated monomer comprising at least one of tetrafluoroethylene, hexafluoropropylene, perfluorinated allyl ethers, perfluorinated vinyl ethers, and combinations thereof.

In one embodiment, the fluorinated polymer may be a semi-crystalline. In one embodiment the fluorinated plastic polymer has a melting point below 150, 120, or even 100° C. In one embodiment, the fluorinated plastic polymer has a melting point of at least 50, 60, or even 70° C. In one embodiment, the fluorinated plastic polymer comprises monomeric unit derived from TFE and HFP, and optionally a perfluorinated vinyl ether and/or perfluorinated allyl ether, along with an iodinated, brominated, and/or chlorinated compound as mentioned above. In one embodiment, the fluorinated plastic polymer is derived from 10 to 20 mol % of a perfluorinated vinyl ether and/or perfluorinated allyl ether. In one embodiment, the fluorinated plastic polymer is derived from 0.05 to 3 mol % of an iodinated, brominated, and/or chlorinated compound as mentioned above.

In one embodiment, the fluorinated polymer has a number average molecular weight of at least 50000, 100000, or even 150000 Dalton; and at most 175000, 200000, 250000, 300000, 350000, 400000, or even 500000 Dalton. Typically, determination of the molecular weight of these polymers is difficult to do by gel permeation chromatography and therefore the molecular weight is determined based on viscosity, if amorphous, or melt flow index (MFI), if semi-crystalline. In one embodiment, the fluorinated polymer has a Mooney viscosity (ML 1+10) at 121° C. of at least 1, 2, 5, 10, 15, or even 20; and at most 50, 60, 80, 100, 120 or even 140 when measured in a manner similar to that disclosed in ASTM D 1646-06. In one embodiment, the fluorinated polymer has an MFI (265° C./5 kg) from at least 1, 2, or even 3 g/10 min; and at most 1000, 500, or even 100 g/10 min.

To form a modified fluorinated polymer, the fluorinated polymer is first dissolved in a non-aqueous liquid vehicle. In one embodiment, the non-aqueous liquid vehicle comprises less than 1, 0.5, 0.1, or even 0.05% by weight of water, or even no detectable amount of water. The non-aqueous liquid vehicle used depends on the fluorinated polymer. For example, a fluorinated solvent (comprising C—F bonds) is appropriate for a perfluorinated polymer, while a fluorinated solvent or non-fluorinated solvent (having no C-F bond) may be used for a partially fluorinated polymer.

Exemplary solvents include perfluorocarbons, hydrochlorofluorocarbons, hydrofluorocarbons, fluorinated ethers (such as perfluoropolyethers and hydrofluoroethers), fluorinated and non-fluorinated ketones (such as acetone, methyl ethyl ketone, methyl isobutyl ketone, methyl amyl ketone and NMP), fluorinated alkyl amines, fluorinated sulfones, non-fluorinated alcohols (such as methanol or ethanol), non-fluorinated ethers such as tetrahydrofuran, 2-methyl tetrahydrofuran and methyl tetrahydrofurfuryl ether; and non-fluorinated esters (such as methyl acetate, ethyl acetate or butyl acetate), non-fluorinated cyclic esters such as delta-valerolactone and gamma-valerolactone. The solvents may be used alone or in combination with one another. When a non-fluorinated solvent is combined with a fluorinated solvent, the concentration non-fluorinated solvent is typically less than 30, 25, 20, 15, 10 or even 5 wt % with respect to the total amount of solvent.

If the fluoropolymer is perfluorinated, a fluorinated solvent is typically required. If the fluoropolymer is partially fluorinated, a fluorinated or non-fluorinated solvent may be used depending on the degree of fluorination of the polymer and the solvent used. One skilled in the art can determine whether or not the fluoropolymer is dissolvable in the solvent, by adding an amount of the fluoropolymer to the solvent, agitating and visually determining if the polymer is in solution.

In one embodiment, the fluorinated ether solvent is a partially fluorinated ether or a partially fluorinated polyether. The partially fluorinated ether or polyether may be linear, cyclic or branched. In one embodiment, the partially fluorinated ether or polyether corresponds to the formula: R¹—O—R wherein R¹ is a perfluorinated or partially fluorinated alkyl group that may be interrupted once or more than once by an ether oxygen and R is a non-fluorinated or partially fluorinated alkyl group, which may be linear, branched, or cyclic. Typically, R¹ may have from 1 to 12 carbon atoms. R¹ may be a primary, secondary or tertiary fluorinated or perfluorinated alkyl residue. This means when R¹ is a primary alkyl residue the carbon atom linked to the ether atoms contains two fluorine atoms and is bonded to another carbon atom of the fluorinated or perfluorinated alkyl chain. In such case, R¹ would correspond to R²—CF₂— and the polyether can be described by the general formula: R²-CF₂—O—R, where R² is a partially fluorinated or perfluorinated alkyl group that may be interrupted once or more than once by an ether oxygen. When R¹ is a secondary alkyl residue, the carbon atom linked to the ether atom is also linked to one fluorine atoms and to two carbon atoms of partially and/or perfluorinated alkyl chains and R¹ corresponds to (R_{f}²R_{f}³)CF—. The polyether would correspond to (R_{f}²R_{f}³)CF—O—R. When R¹ is a tertiary alkyl residue the carbon atom linked to the ether atom is also linked to three carbon atoms of three partially and/or perfluorinated alkyl chains and R¹ corresponds to (R_{f}²R_{f}³R_{f}⁴)—C—. The polyether then corresponds to (R_{f}²R_{f}³R_{f}⁴)—C—OR, where R_{f}²; R_{f}³; and R_{f}⁴ are independently each a partially fluorinated or perfluorinated alkyl group that may be interrupted once or more than once by an ether oxygen; and R is a non-fluorinated or partially fluorinated alkyl group. The groups independently may be linear, branched, or cyclic. Also a combination of polyethers may be used and also a combination of primary, secondary, and/or tertiary alkyl residues may be used.

An example of a solvent wherein R¹ is a partially fluorinated alkyl group includes C₃F₇OCHFCF₃ (CAS No. 3330-15-2). An example of a solvent wherein R¹ is a polyether is C₃F₇OCF(CF₃)CF₂OCHFCF₃ (CAS No. 3330-14-1).

In some embodiments, the partially fluorinated ether solvent corresponds to the formula:

CₚF₂ₚ₊₁—O—C_{q}H_{2q+1}

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚH₂ₚ₊₁ is branched andqis 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluoro-2-(trifluoromethyl)hexane. Such solvents are commercially available, for example, under the trade designation “3M NOVEC ENGINEERED FLUID” from 3M Company, St. Paul, Minn.

In one embodiment, at least 5, 9, or even 10 wt % and at most 15, 18, 20, or even 25 wt % of the fluorinated polymer is dissolved in the non-aqueous liquid vehicle.

A reaction compound having (a) a non-fluorinated terminal olefin group (CH₂═CH—) and (b) comprises a functional group (—X) is reacted with the fluorinated polymer in the presence of a free radical initiator. The reaction compound is functionalized, meaning that the reaction compound comprises a moiety, which imparts a different functionalization onto the fluorinated polymer. Exemplary functional moieties include: alcohol; phosphorous acid and salts thereof; phosphoric acid and salts thereof; carboxylic acid and salts thereof; ester; amine; amide; silane; a hydrocarbon group optionally comprising an in-chain oxygen (i.e., ether), nitrogen (i.e., amine), or sulfur (i.e., thiol) linkage; sulfonyl fluoride; a sulfonic acid and salts thereof; and combinations thereof. This functional group does not react in the presence of the free radical initiator.

In one embodiment, the reaction compound does not homopolymerize.

In one embodiment, the reaction compound is of the structure CH₂═CHX, where X comprises a functional group selected from the group consisting of an alcohol; a phosphorous acid and salts thereof; a phosphoric acid and salts thereof; a silane; an amine; an amide; a hydrocarbon, optionally comprising an in-chain oxygen (i.e., ether), nitrogen (i.e., amine), or sulfur (i.e., thiol) linkage; a carboxylic acid and salts thereof; an ester; a sulfonyl fluoride, a sulfonic acid and salts thereof and combinations thereof X may comprise additional carbon linkages (including non-fluorinated, partially fluorinated, or perfluorinated carbon linkages) and optionally in-chain heteroatoms, such as oxygen (i.e., ether linkages) and nitrogen (i.e., amine linkages). Exemplary reaction compounds include: vinyl phosphonic acid (VPA); vinyl triethoxy silane (VTES); alcohols such as butenol and allyl alcohol, and polyols such as CH₂═CH(—O—)ₙ—(CHOH)ₘ—(CH₂)ₒR, wherein n is 0, 1; m is 2 — 6; o is 0 — 6, R is C₁-C₆ alkyl; allyl phosphates such as allyl dihydrogen phosphate; allyl amine; N-vinyl acetamide; N-vinyl pyrrolidone; 3-butenoic acid; 4pentenoic acid; allyl sulfonyl fluoride; allyl sylfonic acid ans salts thereof such as sodium allyl sulfonate; and vinylacetate. One exemplary reaction compound is of the formula CH₂═CH—O—R—Y, wherein Y is COOH, COOM, SO₂F, SO₃H, SO₃M, P(O)(OH)₂, where M is a cationic metal (e.g., alkali, or alkaline earth metal), which is charge balanced with the Y group, and R is a perfluorinated, partially fluorinated or nonfluorinated alkylene group, such as —(CH₂)ₘ— or —[CF₂—CF(CF₃)O—]ₙ—(CₘF₂ₘ)— wherein n is 0, 1, 2, 3, 4, 5, or 6, and m is an integer from 1, 2, 3, 4, 5, or 6.

Ideally, the reaction compound is soluble in the non-aqueous liquid vehicle, meaning that when mixed in sufficient quantities in the solvent, the reaction compound does not phase separate with the solvent (in the case of a liquid) and that at least a portion of the reaction compound in solid form dissolves in the solvent. Typically, the reaction compound is non-gaseous, meaning that it is a liquid or solid at ambient conditions.

In one embodiment, the equivalent ratio of the reactive group in the reaction compound to the amount of I , Br, and Cl in the fluorinated polymer is at least 1:0.1 and at most 1:10. Preferably, the amount of reaction compound used is in excess of the amount of I, Br, and Cl in the fluorinated polymer, so that the grafting reaction is favored. In one embodiment, the grafted polymer comprises at least 0.5 wt % and no more than 1, 1.5, or even 2 wt % of unreacted iodinated and/or brominated groups in the functionalized fluorinated polymer, which can be subsequently used to crosslink the functionalized fluorinated polymer using, for example, a peroxide cure system.

A free radical initiator, as known in the art, can be used to initiate the reaction of the reaction compound with the fluorinated polymer.

In one embodiment, the free radical initiator includes peroxides such as organic peroxides. In many cases it is preferred to use a tertiary butyl peroxide having a tertiary carbon atom attached to a peroxy oxygen. Exemplary peroxides include: 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, O,O′—1,3-propanediyl OO,OO′-bis(1,1-dimethylethyl) ester, and combinations thereof.

In one embodiment, the free radical initiator includes per-acids such as peracetic acid. Esters of the peracid can be used as well and examples thereof include tert-butylperoxyacetate and tert-butylperoxypivalate. A further class of initiators that can be used are azo-compounds. Suitable redox systems for use as initiators include, for example, a combination of peroxodisulphate and hydrogen sulphite or disulphite, a combination of thiosulphate and peroxodisulphate or a combination of peroxodisulphate and hydrazine. Further initiators that can be used are ammonium- alkali- or earth alkali salts of persulfates, permanganic or manganic acid or manganic acids, peresters or percarbonates.

The amount of free radical initiator used generally will be at least 0.03, 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts by weight of the fluorinated polymer.

The reaction mixture, comprising the fluorinated polymer, the reaction compound, and the free radical initiator in a non-aqueous vehicle is then, for example, heated to initiate the formation of radicals enabling the grafting of the reaction compound onto the fluorinated polymer, which occurs at the I, Br, and Cl sites to form the functionalized fluorinated polymer disclosed above. Typically, the reaction mixture is heated at temperatures of at least 30, 40, 50, or even 75° C. and at most 100, 110, or even 150° C. for at least 1, 2, 4, 6, or even 8 hours and at most 12, 16, 20, 24, 28, or even 36 hours. The reaction is typically conducted at ambient pressures.

Application

Depending on the functionalization, the functionalized fluorinated polymers may be used in a variety of applications.

When the functional group is selected from the group consisting of an alcohol, a phosphoric acid and salts thereof, a phosphorous acid and salts thereof, a carboxylic acid and salts thereof, an amine, or a silane, the functionalized fluorinated polymer may be especially useful in adhering fluorinated polymers to inorganic substrates, for example in coating applications.

In one embodiment, the functionalized fluorinated polymer is used in coating compositions. The functionalized fluoropolymer may be coated directly from the reacted mixture. In another embodiment, the reacted mixture may be diluted prior to coating. In yet another embodiment, the functionalized fluoropolymer in the reacted mixture may be dried and then redissolved to form a coating solution.

A solvent can be used to solubilize or disperse the functionalized fluorinated polymer so as to form a coating composition. Exemplary solvents include: those solvents as disclosed above, as well as glycol ether, tetrahydrofuran, and combinations of solvents. Typically, these solvents are used in small amounts, such as less than 5, 3, 2, 1 or even 0.5 wt %. In one embodiment, the solvent has a boiling point of at least 30, 40, 50, 80, or even 100° C.; and at most 120, 150, 200, 225, or even 250° C. In one embodiment, the solvent is used as a wetting agent, assisting in coating the surface of the substrate. The solvent may or may not be fluorinated and the solvent choice can be guided by the solubility of the fluorinated polymer before functionalization in the particular solvent. In one embodiment, the solvent used in the coating composition is a fluorinated ether as described above, such as 1-methoxyheptafluoroprropane, methoxy-nonafluorobutane, and ethoxy-nonafluorobutane.

Ideally, the coating solution should use a solvent that has a low environmental impact, such as being a non-volatile organic compound (non-VOC), have short atmospheric lifetimes, and having a low global warming potential (GWP). In one embodiment, the solvent has a global warming potential (GWP) of less than 1000, 700, or even 500. In one embodiment, the solvent has atmospheric lifetime of less than 10 years, or even less than 5 years. See U.S. Prov. Pat. Appl. No. 62/671500, filed 15 May 2018 for description of the GWP calculation and the Atmospheric Lifetime Test Method. See 40 CFR (Code of Federal Regulation) § 51.100(s) as of the date of filing for the definition of VOC, a listing of VOCs, and testing for compliance.

In one embodiment, the coating composition comprises at least 0.1, 0.2, 0.5, 1, 1.5, or even 2% by weight of the functionalized fluorinated polymer; and at most 5, 6, 8, 10, 12, 15, 18, or even 25% by weight of the functionalized fluorinated polymer.

For the purpose of, for example, enhancing the strength or imparting the functionality, conventional adjuvants, such as, for example, process aids (such as waxes, carnauba wax); plasticizers such as those available under the trade designation “STRUKTOL WB222” available from Struktol Co., Stow, OH; fillers; and/or colorants may be added to the composition.

Such fillers include: an organic or inorganic filler such as clay, alumina, iron red, talc, diatomaceous earth, barium sulfate, calcium carbonate (CaCO₃), calcium fluoride, titanium oxide, boron nitride, and iron oxide, a polytetrafluoroethylene powder, PFA (TFE/perfluorovinyl ether copolymer) powder, an electrically conductive filler, a heat-dissipating filler, and the like may be added as an optional component to the coating composition.

In one embodiment, carbon black is added to the coating composition. Carbon black fillers are typically employed as a means to balance modulus, tensile strength, elongation, hardness, abrasion resistance, conductivity, and processability of polymer compositions. Suitable examples include MT blacks (medium thermal black) designated N-991, N-990, N-908, and N-907; FEF N-550; and large particle size furnace blacks. When used, 1 to 100 parts by weight of large size particle black filler per hundred parts by weight of the functionalized fluorinated polymer is generally sufficient.

In one embodiment, the composition comprises less than 40, 30, 20, 15, or even 10% by weight of the filler per hundred parts by weight of the functionalized fluorinated polymer.

The coating compositions may be prepared by mixing the functionalized fluorinated polymer, the solvent, and the optional commonly used curing systems for halogenated cure sites, such as peroxides, substitution agent, etc. and optional additives.

In one embodiment, the coating composition comprises at least 5, 10, 20, 25, or even 30% solids and at most 40, 50, 60 or even 70% solids based on weight. Generally, compositions having more solids are preferred.

The coating compositions of the present disclosure may be coated onto substrates, such as inorganic and organic substrates. Exemplary inorganic substrates include, glass, ceramic, glass ceramic, or metals such as carbon steel (e.g., high-carbon steel, stainless steel, aluminized steel), stainless steel, aluminum, aluminum alloys, and combinations thereof. Exemplary organic substrates include, polyvinyl chloride, polycarbonate, polyterephthalate, polyamide, olefinic substrates (such as polyethylene and polypropylene), and combinations thereof.

Ideally, the functional group would be selected to improve adhesion to the particular substrate. For example, for bonding to inorganic substrates, functional groups such as an alcohol (polyol), a phosphonate, a silane, a phosphate, amines, and carboxylic acid may be used. For example, for bonding to organic substrates, functional groups such as amine; or a hydrocarbon, optionally comprising an in-chain oxygen (i.e., ether), nitrogen (i.e., amine), or sulfur (i.e., thiol) linkage, may be preferred.

In the present disclosure, the substrate may be smooth or roughened. In one embodiment, the substrate is treated before use. The substrate may be chemically treated (e.g., chemical cleaning, etching, etc.) or abrasively treated (e.g., grit blasting, microblasting, water jet blasting, shot peening, ablation, or milling) to clean or roughen the surface prior to use.

Bonding agents and primers may be used to pretreat the surface of the organic or inorganic substrate before coating. For example, bonding of the coating to metal surfaces may be improved by applying a bonding agent or primer, such as an amino-silane or alkoxysilane. Exemplary amino-silanes include primary, secondary or tertiary amino-functional compounds according to secondary or tertiary amino-functional compound is represented by formula (R³)₂N—R¹—[Si(Y)ₚ(R²)₃₋ₚ]_{q} wherein R¹ is a multivalent alkylene group optionally interrupted by one or more ether linkages or up to three amine (—NR³—) groups; R² is alkyl or arylalkylenyl; each R³ is independently hydrogen, hydroxy, alkyl, hydroxyalkyl, arylalkylenyl hydroxyarylalkylenyl, or —R¹—[Si(Y)ₚ(R²)₃₋ₚ]; Y is alkoxy, acyloxy, aryloxy, polyalkyleneoxy, halogen, or hydroxyl; p is 1, 2, or 3; and q is 1, 2, or 3, with the provisos that at least two independently selected —Si(Y)ₚ(R²)₃₋ₚ groups are present and that both R³ groups may not be hydrogen, as disclosed in US Pat. Publ. Nos. 2017-0081523 (Audenaert) and 2018-0282578 (Audenaert et al.), herein incorporated by reference. In some embodiments, such alkoxy silanes may be characterized as “non-functional” having the chemical formula:

R²Si(OR¹)ₘ

wherein R¹ is independently a multivalent alkylene group optionally interrupted by one or more ether linkages or up to three amine (—NR³—) groups;
R² is independently hydrogen, alkyl, aryl, alkaryl, or OR¹ wherein R¹ is a multivalent alkylene group optionally interrupted by one or more ether linkages or up to three amine (—NR³—) groups; and
m is 1, 2, or 3, and is typically 2 or 3.

Suitable alkoxy silanes of the formula R²Si(OR¹)m include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane dimethyldimethoxysilane and dimethyldiethoxysilane.

Preferably, the alkyl group(s) of the alkoxy silanes comprises from 1 to 6, more preferably 1 to 4 carbon atoms. Preferred alkoxysilanes for use herein are selected from the group consisting of tetra methoxysilane, tetra ethoxysilane, methyl triethoxysilane, dimethyldiethoxysilane, and any mixtures thereof. A preferred alkoxysilane for use herein comprises tetraethoxysilane (TEOS). The alkoxy silane lacking organofunctional groups utilized in the method of making the coating composition may be partially hydrolyzed, such as in the case of partially hydrolyzed tetramethoxysilane (TMOS) available from Mitsuibishi Chemical Company under the trade designation “MS-51”.

Examples of commercial primers or bonding agents, include, for example those available under the trade designation CHEMLOK 5150 and CHEMLOK 8116, available from Lord Corp., Cary, N.C. In one embodiment, the articles of the present disclosure, do not comprise a primer between the substrate and the functionalized fluorinated polymer composition.

The substrate may be imbibed or coated with the coating solution as disclosed herein using conventional techniques known in the art, including but not limited to, dip coating, roll coating, painting, spray coating, knife coating, gravure coating, extrusion, die-coating, and the like. The coating may be colored in cases where the compositions contains pigments, for example titanium dioxides or black fillers like graphite or soot, or it may be colorless in cases where pigments or black fillers are absent.

After coating, the solvent may be advantageously reduced or completely removed, for example by evaporation, drying or by boiling the solvent away from the sample. The coated sample can be heated at temperatures of room temperature or even higher, for example up to 100° C. or even 180° C. to remove solvent, depending on the solvent and the substrate used.

Typically, the coated sample is dried at room temperature and/or heated to bond the fluoropolymer composition to the substrate and optionally cure the functionalized fluorinated polymer. In one embodiment, the coated sample is heated at a temperature of at least 75, 80, 90, 100, 120, or even 130° C.; and at most 150, 200, 220, 250 or even 300° C., for a period of at least 2, 5, 10, 15, 30, or even 60 minutes; and at most 2, 5, 10, 15, 24, 36, or even 48 hours depending on the cross-sectional thickness of the coating. For thick sections of coating, the temperature during the heating step is usually raised gradually from the lower limit of the range to the desired maximum temperature. In some embodiments, processing of the coated article is carried out by conveying the coated article through an oven with an increasing temperature profile from entrance to exit.

In one embodiment, the cured coating is at least 12, 15, 20, 25, 50, or even 100 micrometers thick; and at most 500, 1000, or even 2000 micrometers thick. In one embodiment, the cured coating is a thin coating with a thickness of at least 20, 30, 40, 50, 75, or even 100 nanometers (nm); and at most 120, 150, 200, 500, 750, or even 1000 nm thick.

In one embodiment, the coating compositions of the present disclosure have adhesion to the substrate. For example, when rubbed with solvent the coating layer is not removed from the substrate in less than 5 cycles. For example, after being immersed for 60 minutes in boiling water and upon peeling, the layer of coating cannot be removed from the substrate or if parts of the coating layer break, the break is not at the substrate coating interface.

In one embodiment, the coating compositions of the present disclosure provide stain release to the underlying substrate. For example, in one embodiment, the coating compositions of the present disclosure when applied to substrates have an improved stain release properties against permanent ARTLINE BLUE marker.

In one embodiment, the coating composition when tested for stain release after wet abrasion, the coated sample has a stain release of at least 1.5 or even 2.0.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

Test Methods and Procedures:

Nuclear Magnetic Resonance (NMR) spectroscopy:

Proton, ¹⁹F and ¹³C NMR spectra were run on a 300 MHz NMR from Bruker Corp., Billerica, Mass.

Mooney Viscosity:

Mooney viscosities were determined in accordance with ASTM D1646-07(2012), a 1-minute pre-heat and a 10-minute test at 121° C. (ML 1+10 at 121° C.).

Viscosity:

Brookfield viscosities were measured using a Brookfield LVDV-II+Pro viscometer using spindle S62 at room temperature (20-23° C.).

Static Contact Angle Measurement (HCA and WCA)

The static contact angles versus hexadecane (HCA) and water (WCA) were measured on coated and uncoated test panels before and optionally after being subjected to Abrasion Testing. For the WCA measurements, deionized water was used that was filtered through a filtration system obtained from Millipore Corporation (Billerica, Mass.). The measurements were done using a DSA100 Contact Angle Analyzer (commercially available from Krüss GmbH, Germany). The water contact angles were measured one day after the preparation of the coatings, on drops having a volume of 5 microliters, 30 seconds after deposition. The values of the contact angles are the averages of 9 measurements (three drops on three coated substrates) and are reported in degrees (°).

Mechanical Wet Abrasion Testing:

Abrasion tests were performed on coated test panels, using a Scrub Resistance Tester (commercially available from Erichsen GmbH & Co., Germany) during 4000 cycles with no force applied. The cloth used for the abrasion cycles was the yellow side of a “SCOTCHBRITE” sponge (commercially available from the 3M Company, USA) wetted with deionized water.

Stain Repellency Test:

Stain stripes of 10 mm×50 mm were applied on the coated substrate using an Artline blue permanent marker. The repellency was rated on a scale of 1 to 5, where “1” means the marker fully beads up and “5” means the marker wets the surface completely

Ease of Stain Removal Test (ST)

A marker stain (using a permanent marker, commercially available under tradename ARTLINE 100N) with a width of 5-10 mm and a length of 30-40 mm was applied onto coated and uncoated test panels. The marked test panel was then dried for 30 minutes at room temperature, before carrying out the stain removal procedure. The ease of stain removal was evaluated by rubbing the stained surface for 20 seconds with a dry cotton cloth. The stain removal was rated on a scale ranging from 1 to 3, wherein 1 means “easy removal”, 2 means “medium removal and 3 means “difficult removal”.

Stain Release Test (SR)

After rubbing the stain for 20 seconds with a dry cotton cloth (stain removal test above), the residual stain was visually rated according to the 8-point scale, wherein “1” means completely stained and “'8” means there was no stain visible.

Test Substrates

Stainless Steel Panels

Stainless steel panels were obtained from Rocholl GmbH, Germany (Type 1.403 IIID, having a dimension of 125 mm×75 mm×2 mm). Prior to use, the stainless steel test panels were cleaned with MEK, then heptane and again MEK.

Glass Panels

Standard float glass was cut in pieces from 150 mm×50 mm. The glass panels were cleaned with glass cleaner and a multipurpose cleaner available under the trade designation “CIF CREAM CLEANER” available from the household section of a retail store, followed by rinsing with water and acetone.

Before applying the coating formulations, the cleaned test panels were allowed to dry at room temperature for a minimum of 1 hour.

Coating Procedure

Coating formulations were prepared by adding the designated fluorinated polymer in small pieces to HFE-7300 solvent in 100 ml vials to obtain 0.2% fluorinated polymer solution. The vials were put on a Lab-Shaker (available from Adolf Kuhner AG, Switzerland) at 250 revolutions per minute (rpm) until homogeneous solutions were obtained.

In order to optimize the bonding, the substrates were optionally pre-coated by spray application with a solution of an aminosilane primer (BTMSPA). Typical spray conditions were using an air-atomized spray gun at a pressure of 2 bar and flow rate of 40 milliliters/minute. Two crosses were applied, and the primer layer was dried for 3 hours at room temperature (RT).

The coating formulations according to the present disclosure were applied directly to the substrate or alternatively, where applicable onto the primer layer as given above, using an RDC-21 dip-coater available from Bungard (Germany). Hereby the test panels were immersed vertically into the coating formulations at a speed of 300 millimeters per minute (mm/min). Once the parts were fully immersed, they were held in the bath for 15 seconds.

The test panels were taken out of the bath at a speed of 300 mm/min and dried vertically at room temperature for 1 minute, followed by vertical drying at 85° C. for 30 minutes. Each coating formulation was coated on 3 test panels.

### Materials

| NAme | Description |
|---|---|
| Allyl alcohol | CH₂═CH—CH₂—OH, available from Sigma-Aldrich |
| BTMSPA | bis(trimethoxysilylpropyl) amine, Silquest A-1170 |
| | available from Momentive, Waterford, NY |
| 3-Buten-1ol | CH₂═CH—CH₂CH₂—OH, available from Sigma-Aldrich |
| 10-Undecen- | CH₂═CH—(CH₂)₈—CH₂—OH, available from Sigma- |
| 1-ol | Aldrich |
| MV32I | Perfluoro-[(6-iodo-4-oxa-hexyl)-vinyl]-ether, available |
| | from Anles Plus, St. Petersburg, Russia |
| VPA | vinyl phosphonic acid, available from Sigma-Aldrich |
| VTES | vinyl triethoxysilane, available from Sigma-Aldrich |
| FFKM 1 | A peroxide curable iodinated TFE/PMVE |
| | perfluoropolymer having about 72% F, a Mooney |
| | Viscosity (raw gum) ML 1 + 10@121° C. of about 40 |
| | and iodine content of about 0.4 wt %, generally prepared |
| | as described in U.S. Pat. No. 9,982,091. |
| FKM 1 | A peroxide curable Iodinated VDF/HFP fluoroelastomer |
| | having about 66% F, a Mooney Viscosity (raw gum) ML |
| | 1 + 10@100° C. of about 3.5 and Iodine content of about |
| | 0.65 wt %. Prepared generally according to Example 17 |
| | of U.S. Pat. No. 8,835,551. |
| FKM 2 | A peroxide curable Iodinated VDF/HFP/TFE |
| | fluoroelastomer having about 67.3% F, a Mooney |
| | Viscosity (raw gum) ML 1 + 10@121° C. of about 50 |
| | and Iodine content of about 0.3 wt %. Prepared generally |
| | according to U.S. Pat. No. 8,835,551. |
| HFE-7300 | 3-methoxyperfluoro(2-methylpentane) hydrofluoroether |
| | available under the trade designation “3M NOVEC 7300 |
| | ENGINEERED FLUID” from 3M Co., Maplewood, MN |
| HFE-7500 | 3-ethoxyperfluoro(2-methylhexane) hydrofluoroether |
| | available under the trade designation “3M NOVEC 7500 |
| | ENGINEERED FLUID” from 3M Co. |
| V-59 | Azo-initiator available as V-59 from FUJIFILM Wako |
| | Chemicals USA, Richmond, VA |

### EXAMPLES

### Example EX-1

In example EX-1, functionalized fluorinated polymer 1 was prepared by the reaction of FFKM 1 with Ally! alcohol in an equivalent ratio of iodo group to double bond of 1:2. Therefore, a 100 ml (milliliter) reaction bottle was charged with small pieces of FFKM 1 raw gum (10.00 g (gram)); and 40.15 g HFE-7300 and heated in a Launder-O-meter for 2 hours at 75° C., resulting in a clear homogeneous solution. Ally! alcohol (37 mg; 0.646 meq.) and 50 mg V-59 were added after cooling. The bottle was degassed with waterjet vacuum, followed by breaking the vacuum with nitrogen atmosphere. This procedure of degassing and breaking the vacuum was repeated 3 times. The reaction bottle then was sealed and run for 16 hours in a preheated Launder-O-meter at 75° C. After cooling, 50 mg V-59 was added, the bottle was again degassed and covered with nitrogen atmosphere. The reaction bottle was then run for another 16 hours at 75° C., yielding a hazy viscous solution containing 20% polymer solids.

The solvent and remaining excess allyl alcohol were distilled off with a Büchi rotary evaporator using waterjet vacuum, resulting in light yellow, solids.

The product structure of functionalized fluorinated polymer 1 was confirmed by proton NMR analysis where signals attributed to the CHI—CH₂—OH moiety appeared at 3.9 and 4.5 ppm. At the same time, the double bond signals for the allyl alcohol were no longer present. The product structure of Fluorinated polymer 1 was further confirmed by F19 NMR analysis. The signals of the —CF₂CF₂—I moiety from the starting material −53.77 and −56.39 ppm disappeared after the reaction.

### Example EX-2

In example EX-2, functionalized fluorinated polymer 2 was prepared by radical insertion reaction of FFKM 1 with 3-buten-1-ol in an equivalent ratio 1:2. The reaction was done essentially according to the same procedure as outlined for the synthesis of functionalized fluorinated polymer 1, but using the appropriate reagent as given in table 1.

### Examples EX-3 and EX-4

In examples EX-3 and EX-4, functionalized fluorinated polymers 3 and 4 were prepared by reaction of FFKM 1 with 10-undecen-1-ol (in an equivalent ratio 1:2) and VPA (in an equivalent ratio 1:10), respectively. The reactions were done essentially according to the same procedure as outlined for the synthesis of functionalized fluorinated polymer 1, using the appropriate amounts of reagents as given in table 1. In these cases however, after the reactions, only the solvent was removed. The excess reactant, 10-undecen-1-ol or VPA, was not removed due to the higher boiling point.

### Example EX-5

In example EX-5, functionalized fluorinated polymer 5 was prepared by reaction of FFKM 1 with VTES (in an equivalent ratio 1:2) using essentially the same procedure as outlined for the synthesis of functionalized fluorinated polymer 1, using the appropriate amounts of reagents as given in table 1. However, the solvent and excess VPES were not removed after the reaction to avoid reaction of the silane groups.

### Example EX-6

In example EX-6 functionalized fluorinated polymer 6 was prepared by the radical insertion reaction of functionalized fluorinated polymer FKM 1 with 3-buten-1-ol (in an equivalent ratio 1:5). Therefore, a 250 ml reaction bottle was charged with small pieces of FKM 1 raw gum (25.00 g; 0.67 Iodine meq.) and 143.03 g MEK and put on a Lab-Shaker (available from Adolf Kuhner AG, Switzerland) at 250 rpm until the polymer was completely dissolved. Then 3-buten-lol (241 mg; 3.35 meq.) and 126 mg V-59 were added. The bottle was degassed with waterjet vacuum, followed by breaking the vacuum with nitrogen atmosphere. This procedure was repeated 3 times. The reaction bottle was sealed and run for 16 hours in a preheated Launder—O—meter at 75° C. After cooling 126 mg V-59 was added, the bottle was again degassed and covered with nitrogen atmosphere. The reaction bottle was then run for another 16 hours at 75° C., yielding a quasi-clear non-viscous solution containing 15% polymer solids.

The solvent and remaining excess butenol were distilled off with a Büchi rotary evaporator using waterjet vacuum, resulting in white, elastic polymer solids.

### Example EX-7

In example EX-7, functionalized fluorinated polymer 7 was prepared by reaction of FKM 2 with 3-buten-1-ol (in an equivalent ratio 1:5). The reaction was done essentially according to the same procedure as outlined for the synthesis of functionalized fluorinated polymer 6, but using the appropriate reagents as given in table 1.

A summary of the composition of the functionalized fluorinated polymers of EX-1 to EX-7 can be found in table 1, where Eq ratio is the ratio of iodinated groups versus the reaction compound. Table 1 further lists some characteristics of the functionalized fluorinated polymers in comparison to their respective starting fluorinated polymers (C-1 to C-3).

TABLE 1

| | | | | | Appearance |
|---|---|---|---|---|---|
| | | | | | dried |
| | Functionalized | | | | functionalized |
| | fluorinated | Fluorinated | Reaction | Eq | fluorinated |
| Example | polymer | polymer | compound | Ratio | polymer |
| EX-1 | 1 | FFKM 1 | Allyl acohol | 1/2 | Light yellow |
| EX-2 | 2 | FFKM 1 | 3-buten-1-ol | 1/2 | Light yellow |
| EX-3 | 3 | FFKM 1 | 10-undecen- | 1/2 | Almost white |
| | | | 1-ol | | |
| EX-4 | 4 | FFKM 1 | VPA | 1/10 | White |
| EX-5 | 5 | FFKM 1 | VTES | 1/2 | Sample not |
| | | | | | dried |
| C-1 | NA | FFKM 1 | NA | NA | White |
| EX-6 | 6 | FKM 1 | 3-buten-1-ol | 1/5 | Yellow |
| C-2 | NA | FKM 1 | NA | NA | Yellow |
| EX-7 | 7 | FKM 2 | 3-buten-1-ol | 1/5 | Almost white |
| C-3 | NA | FKM 2 | NA | NA | White |

NA = not applicable

As can be seen from table 1, the functionalization of the fluorinated polymers has minor influence on the color.

The solubility of the functionalized fluorinated polymers of examples EX-1 to EX-4 were evaluated in HFE-7300. Therefore 250 ml reaction bottles were charged with small pieces of functionalized fluorinated polymers 1 to 4 respectively and an amount of HFE-7300 to obtain solutions as given in table 2. The mixtures were put on a Lab-Shaker (available from Adolf Kühner AG, Switzerland) at 250 rpm (revolutions per minute) overnight. Functionalized fluorinated polymers 1 to 3 seemed to be completely dissolved. Functionalized fluorinated polymer 4 formed a milky dispersion in HFE-7300 at 5 wt % solids. The viscosity was measured as outlined above. The results of viscosity and appearance of the mixtures are listed in table 2.

TABLE 2

| | Functionalized | | | |
|---|---|---|---|---|
| | Fluorinated | % solids in | Viscosity | |
| Example | polymer | HFE-7300 | (mPas · s) | Appearance |
| EX-1 | Ex-1 | 10(*) | 310 | Hazy solution |
| EX-2 | Ex-2 | 10(*) | 366 | Slightly hazy solution |
| EX-3 | Ex-3 | 10(*) | 332 | Hazy solution |
| EX-4 | Ex-4 | 5 | NA | Milky dispersion |
| C-1 | None-FFKM 1 | 10(*) | 242 | Clear solution |
| | used | | | |

NA: not available
Note:
(*) increasing the solids to 15% had minor influence on the viscosity and appearance of the solutions.

### Examples EX-8 to EX-11 and Reference Example REF-1

Examples EX-8 to EX-11 were made by first preparing coating solutions of the functionalized fluorinated polymers from examples EX-1, EX-2, EX-4 and EX-5 (as given in table 1) in HFE-7300 at a concentration of 0.2% solids. Cleaned stainless steel test panels were coated directly with the thus obtained solutions. Each formulation was coated on 3 different test panels, using the coating procedure as outlined above. The coated test panels were conditioned at room temperature overnight. The coated test panels were tested for their stain release properties, before and after wet abrasion, according to the methods described above. The results, compared to uncoated stainless steel test panels (REF-1), are recorded in table 3.

TABLE 3

| | Polymer used | Stain release Artline Blue | | | | | |
|---|---|---|---|---|---|---|---|
| | in Coating | Initial | | | After wet abrasion | | |
| | formulation in | | Ease | | | Ease | |
| | HFE-7300 | Stain | stain | Stain | Stain | stain | Stain |
| Example | (0.2%) | repellency | removal | release | repellency | removal | release |
| EX-8 | Ex-1 | 3.5 | 3.0 | 1.5 | 4.7 | 3.0 | 1.5 |
| EX-9 | Ex-2 | 3.2 | 3.0 | 2.3 | 5.0 | 3.0 | 1.8 |
| EX-10 | Ex-4 | 3.8 | 3.0 | 2.7 | 5.0 | 3.0 | 1.0 |
| EX-11 | Ex-5 | 4.0 | 3.0 | 2.0 | 5.0 | 3.0 | 2.0 |
| REF-1 | NA | 5.0 | 3.0 | 1.0 | 5.0 | 3.0 | 1.0 |

As can be seen from the data, the functionalized fluorinated polymers according to the present disclosure have better stain repellency and stain resistance properties compared to non-modified fluorinated polymers.

### Examples EX-12 to EX-19, Comparative Examples C-4 and C-5 and Reference Examples REF-2 and REF-3

In examples EX-12 to EX-19 cleaned stainless steel test panels were pre-coated with a BTMSPA primer in a concentration as given in table 4 and according to the general procedure given above. After drying, the stainless steel test panels were coated with 0.2% wt solutions of the fluorinated polymers in HFE-7300, as given in table 4. The coated test panels were conditioned at room temperature overnight. The static contact angles (WCA & HCA) and stain release properties against ARTLINE BLUE marker, before and after wet abrasion, were measured according to the methods described above. Comparative examples C-4 and C-5 were made in the same way with unmodified FFKM1. Reference examples REF-2 and REF-3 represent the results of stainless steel panels that were only coated with BTMSPA primer. The results are the average values of 3 test panels and are represented in tables 4 and 5.

TABLE 4

| | Polymer | BTMSPA | WCA (°) | | HCA (°) | |
|---|---|---|---|---|---|---|
| Example | used | (%) | Initial | Abrasion | Initial | Abrasion |
| EX-12 | Ex-1 | 0.1 | 115 | 94 | 63 | 55 |
| EX-13 | | 1 | 116 | 107 | 63 | 58 |
| EX-14 | Ex-2 | 0.1 | 115 | 92 | 63 | 50 |
| EX-15 | | 1 | 117 | 109 | 64 | 59 |
| EX-16 | Ex-4 | 0.1 | 112 | 69 | 60 | 42 |
| EX-17 | | 1 | 115 | 92 | 63 | 54 |
| EX-18 | Ex-5 | 0.1 | 114 | 107 | 65 | 62 |
| EX-19 | | 1 | 115 | 107 | 66 | 62 |
| C-4 | FFKM | 0.1 | 114 | 84 | 62 | 46 |
| C-5 | 1 | 1 | 116 | 98 | 62 | 54 |
| REF-2 | NA | 0.1 | 66 | 59 | Spreads | Spreads |
| REF-3 | | 1 | 60 | 60 | Spreads | Spreads |

Note:
spreads: the drop spreads onto the surface. No measurement of HCA could be made

TABLE 5

| | Stain release Artline Blue | | | | | |
|---|---|---|---|---|---|---|
| | Initial | | | After wet abrasion | | |
| | | Ease | | | Ease | |
| | Stain | stain | Stain | Stain | stain | Stain |
| Example | repellency | removal | release | repellency | removal | release |
| EX-12 | 1.0 | 1.8 | 6.8 | 2.3 | 3.0 | 3.3 |
| EX-13 | 1.0 | 1.0 | 8.0 | 1.0 | 2.0 | 7.7 |
| EX-14 | 1.0 | 2.5 | 5.2 | 2.2 | 3.0 | 4.2 |
| EX-15 | 1.0 | 1.0 | 8.0 | 1.0 | 2.0 | 7.7 |
| EX-16 | 1.2 | 3.0 | 4.7 | 5.0 | 3.0 | 3.8 |
| EX-17 | 1.0 | 2.7 | 5.5 | 4.5 | 3.0 | 4.3 |
| EX-18 | 1.0 | 1.3 | 7.7 | 1.0 | 2.0 | 7.0 |
| EX-19 | 1.0 | 1.0 | 8.0 | 1.0 | 1.7 | 7.7 |
| C-4 | 1.8 | 3.0 | 3.5 | 3.0 | 3.0 | 2.2 |
| C-5 | 1.2 | 2.5 | 4.7 | 1.0 | 2.3 | 4.5 |
| REF-2 | 5 | 3 | 1 | 5 | 3 | 1 |
| REF-3 | 5 | 3 | 1 | 5 | 3 | 1 |

### Examples EX-20 and EX-21 and Comparative Examples C-6 and C-7 and Reference Examples REF-4 and REF-5

In examples EX-20 and EX-21 and comparative examples C-6 and C-7, in a first step, 0.2% solids coating solutions were prepared of functionalized fluorinated polymer 5 (EX-20 and EX-21) or FFKM 1 (C-6 and C-7) respectively in HFE-7300 according to the procedure outlined above. Prior to applying the coating composition to glass panels, the glass panels were cleaned and pre-treated, according to the general procedure given above, with a silane primer (BTMSPA) at different concentrations as given in tables 6 and 7. After drying, the primed glass panels were coated with the fluorinated polymer coating composition as outlined above. The coated test panels were conditioned at room temperature overnight. In reference examples REF-4 and REF-5, the glass panels were only coated with BTMSPA primer. The static contact angles (WCA & HCA) and stain release properties against ARTLINE BLUE marker, before and after wet abrasion, were measured according to the methods described above. The results are the average values of 3 test panels and are recorded in tables 6 and 7.

TABLE 6

| | Polymer | BTMSPA | WCA (°) | | HCA (°) | |
|---|---|---|---|---|---|---|
| Example | used | (%) | Initial | Abrasion | Initial | Abrasion |
| EX-20 | Ex-5 | 0.1 | 111 | 102 | 61 | 44 |
| EX-21 | | 1 | 114 | 110 | 63 | 61 |
| C-6 | FFKM | 0.1 | 111 | 62 | 63 | Spreads |
| C-7 | 1 | 1 | 115 | 64 | 62 | Spreads |
| REF-4 | NA | 0.1 | 66 | 59 | Spreads | Spreads |
| REF-5 | | 1 | 58 | 52 | Spreads | Spreads |

TABLE 7

| | Stain release ARTLINE BLUE | | | | | |
|---|---|---|---|---|---|---|
| | Initial | | | After wet abrasion | | |
| | Stain | Ease | | Stain | Ease | |
| | repel- | stain | Stain | repel- | stain | Stain |
| Example | lency | removal | resistance | lency | removal | resistance |
| EX-20 | 1 | 1 | 8 | 1 | 2 | 8 |
| EX-21 | 1 | 1 | 8 | 1 | 1 | 8 |
| C-7 | 3 | 3 | 3 | 5 | 3 | 2 |
| C-8 | 1 | 3 | 8 | 5 | 3 | 3 |
| REF-4 | 5 | 3 | 1 | 5 | 3 | 1 |
| REF-5 | 5 | 3 | 1 | 5 | 3 | 1 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A method of grafting a nonfluorinated segment onto a fluorinated polymer to form a functionalized fluorinated polymer, the method comprising:
dissolving the fluorinated polymer having a number average molecular weight of at least 50,000 g/mol in a non-aqueous vehicle, wherein the fluorinated polymer comprises at least one Br, I, and Cl group and is substantially free of —CH₂CH₂— linkages; and
reacting the fluorinated polymer with at least one reaction compound comprising (a) a non-fluorinated terminal olefin group and (b) a functional group, in the presence of a free radical initiator.

2. The method of claim 1, wherein the fluorinated polymer comprises at least one Br, and I group.

3. The method of claim 1, wherein the fluorinated polymer is an amorphous polymer.

4. The method of claim 1, wherein the fluorinated polymer is derived from:
(a) a halogenated compound comprising at least one of
(i) a fluorinated di-iodo ether compound of the following formula III:
R_{f}′—CF(I)—(CX′X′)ₐ—(Z¹)_{b}—O—R_{f}¹O—(Z¹)_{c}—(CX′X′)_{d}—CF(I)—R_{f}′
wherein
each R_{f}′ is independently selected from F and a monovalent perfluoroalkane having 1-3 carbons;
each Z¹ is independently selected from —CX′X′CX′R_{f}″— and —CX′R_{f}″CX′X′—;
each X′ is independently selected from F and Cl;
R_{f}″ is F, or a perfluorinated alkane comprising 1-3 carbons;
R_{f}¹ is a divalent perfluorinated alkylene having 1-5 carbons or a divalent perfluorinated alkylene ether having 1-8 carbons and at least one ether linkage;
v is 0 or 1; and
a, b, c, and d are independently selected from an integer from 0-5, with the proviso that when v is 0, a+b is at least 1 and c+d is at least 1;
(ii) CF₂═CF—Rf—Q, wherein Rf is a perfluorinated alkylene, optionally comprising at least one in-chain ether linkage and Q comprises at least one of I, Br, and Cl; and
(iii) I—(CF₂)_{w}—I wherein w is an integer from 1-8; and
(b) a fluorinated monomer comprising at least one of tetrafluoroethylene, hexafluoropropylene, vinylidene fluoride, perfluorinated allyl ethers, perfluorinated vinyl ethers, and combinations thereof.

5. The method of claim 1, wherein the fluorinated polymer is a perfluorinated polymer.

6. The method of claim 1, wherein the fluorinated polymer comprises at least 0.4% to at most 5% by weight of Br, I, and Cl versus the total weight of the fluorinated polymer.

7. The method of claim 1, wherein the fluorinated polymer has a number average molecular weight of at least 50,000 g/mol and at most 500,000 g/mol.

8. The method of claim 1, wherein the non-aqueous vehicle comprises a fluorinated solvent, optionally, wherein the fluorinated solvent comprises at least one of a perfluorinated alkane, a perfluorinated amine, a perfluorinated ether, and a hydrofluoroether.

9. The method of claim 1, wherein the functional group is selected from the group consisting of an alcohol; phosphorous acid and salts thereof; phosphoric acid and salts thereof; a silane; an amine; an amide; a hydrocarbon, optionally comprising an in-chain oxygen, nitrogen, or sulfur linkage; a carboxylic acid and salts thereof; an ester; a sulfonyl fluoride, a sulfonic acid and salts thereof; and combinations thereof.

10. The method of claim 1, wherein the free radical initiator comprises at least one of a persulfate, a perester, a percarbonate, an azo, and a peroxide, optionally, wherein the free radical initiator is selected from ammonium persulfate, (di)alkyl-peroxide, diacyl-peroxide and hydroperoxide.

11. A functionalized fluorinated polymer comprising a perfluorinated polymer backbone with pendent groups therefrom, the perfluorinated polymer backbone having a number average molecular weight of at least 50,000 g/mol, wherein at least one pendent group is according to formula I: 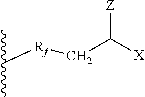
Where Rf is a bond or a divalent perfluorinated group, optionally comprising at least one in-chain ether linkage; Z is I, Br, or Cl; and X comprises a functional group selected from the group consisting of an alcohol; phosphorous acid and salts thereof; phosphoric acid and salts thereof; a silane; an amine; an amide; a hydrocarbon, optionally comprising an in-chain oxygen, nitrogen, or sulfur linkage; a carboxylic acid and salts thereof; an ester; a sulfonyl fluoride, a sulfonic acid and salts thereof; and combinations thereof.

12. The functionalized fluorinated polymer of claim 11, wherein the functionalized fluorinated polymer comprises interpolymerized tetrafluoroethylene monomeric units.

13. The functionalized fluorinated polymer of claim 11, wherein the functionalized fluorinated polymer comprises interpolymerized perfluorinated ether monomeric units.

14. The functionalized fluorinated polymer of claim 11, wherein the functionalized fluorinated polymer has a Mooney Viscosity (ML 1+10) at 121° C. of between 5-100.

15. The functionalized fluorinated polymer of claim 11, wherein the functionalized fluorinated polymer has an MFI of at least 1 g/10 min and at most 1000 g/10 min.

16. A coating composition comprising the functionalized fluorinated polymer of claim 11 and a fluorinated solvent, optionally, wherein the fluorinated solvent comprises at least one of hydrofluoroether and perfluoroketone.

17. The coating composition according to claim 16, further comprising a filler.

18. A method of making a coated article, the method comprising: coating a substrate with the coating composition according to claim 16 onto a substrate, optionally, wherein the substrate comprises at least one of glass, ceramic, and metal, wherein the metal is optionally selected from stainless steel, carbon steel, or aluminum.

19. The method of claim 18, wherein the substrate is first coated with a primer before disposing the coating composition thereon, optionally, wherein the primer is at least one of an amino-silane, and an alkoxysilane.

20. (canceled)

21. An article comprising an inorganic substrate and a fluoropolymer composition bonded thereto, the fluoropolymer composition comprising the functionalized fluorinated polymer according to claim 11, optionally, wherein the fluoropolymer composition has a thickness of at least 30 nm.
